(19) United States
(12) Patent Application Publication
(10) Pub. No.: US 2013/0216459 A1
(43) Pub. Date: Aug. 22, 2013

(54) LOWER TEMPERATURE MIXING ZONE FOR NH3

(71) Applicants: Brad J. Adelman, Chicago, IL (US); Edward M. Derybowski, Hanover Park, IL (US); Shyam Santhanam, Aurora, WI (US)

(72) Inventors: Brad J. Adelman, Chicago, IL (US); Edward M. Derybowski, Hanover Park, IL (US); Shyam Santhanam, Aurora, WI (US)

(21) Appl. No.: 13/882,927

(22) PCT Filed: Nov. 1, 2010
(86) PCT No.: PCT/US10/54991

§ 371 Date: May 1, 2013

(51) Int. Cl. B01D 53/92

(52) U.S. Cl. CPC B01D 53/92
USPC 423/212

(57) ABSTRACT

A method fluidly coupling components of an exhaust gas treatment system to an exhaust gas system, then injecting gaseous ammonia into the gas treatment system, beginning reaction of gaseous ammonia with exhaust gas at a temperature of less than about 180° C., preferably about 150° C., and then continuing reaction of gaseous ammonia with exhaust gas during operation of the vehicle, is disclosed. The gas treatment system includes a mixing chamber for reacting gaseous ammonia with exhaust gas to reduce NOₓ in the exhaust gas. Other components of the system include a diesel oxidation catalyst (DOC), a diesel particulate filter (DPF), a NOₓ slip catalyst (NSC) canister, wherein the DOC, DPF and NSC are all fluidly coupled together and to the mixing chamber, an injection port for adding gaseous ammonia to the mixing chamber, and a solid ammonia source for supplying gaseous ammonia to the injection port.

### TECHNICAL FIELD OF THE INVENTION

The present invention relates to an apparatus and method for treating and mixing diesel exhaust in a diesel exhaust system. Particularly, the present invention provides methods for injecting reagent into a diesel exhaust stream to reduce nitrogen oxides (NOₓ) while reducing packaging space, lowering the starting reaction temperature, facilitating certification and preventing clogging of the exhaust gas system.

### BACKGROUND OF THE INVENTION

Diesel engines are efficient, durable and economical. Diesel exhaust, however, can harm both the environment and people. To reduce this harm, governments, such as the United States and the European Union, have proposed stricter diesel exhaust emission regulations. These environmental regulations require diesel engines to meet the same pollution emission standards as gasoline engines.

Typically, to meet such regulations and standards, diesel engine systems require equipment additions and modifications. Additional equipment can often lead to additional weight and/or additional packaging length.

For example, a lean burning engine provides improved fuel efficiency by operating with an amount of oxygen in excess of the amount necessary for complete combustion of the fuel. Such engines are said to run “lean” or on a “lean mixture.” However, the increase in fuel efficiency is offset by the creation of undesirable pollution emissions in the form of nitrogen oxides (NOₓ). Nitrogen oxide emissions are regulated through regular emission testing requirements. One method used to reduce NOₓ emissions from lean burn internal combustion engines is known as selective catalytic reduction. When used to reduce NOₓ emissions from a diesel engine, selective catalytic reduction involves injecting atomized urea into the exhaust stream of the engine in relation to one or more selected engine operational parameters and running the stream through a reactor containing a catalyst.

However, selective catalytic reduction and the use of aqueous urea involve many disadvantages. For example, the urea must first be reacted to form ammonia (NH₃) before it can reduce the NOₓ emissions. Accordingly, packaging length and weight must be great enough to accommodate the intermediate reaction. Further, while NH₃ reacts at a temperature of about 150° C., urea needs to achieve about 180° C. to begin reaction. Accordingly, reduction of NOₓ is unnecessarily delayed by the intermediate reaction converting urea to ammonia. The higher required reaction temperature of a urea system may also lead to more difficult engine certification under any Federal Test Procedure (FTP) having a cold cycle component.

Still another disadvantage of aqueous urea exhaust treatment is the propensity for clogging of the exhaust stream, causing pressure drops which can foul system sensors. When combined with soot prevalent in an exhaust gas stream, the gas/liquid urea will form blockages and add excess weight in the treatment canisters. Finally, the highly corrosiveness and poor lubricity of aqueous urea make it an unsuitable exhaust gas treatment component.

It would be advantageous to provide methods and apparatus for addressing the regulations and standards without adding weight or length to an already complex diesel exhaust system. Accordingly, it would be advantageous to provide methods and apparatus for injecting a NOₓ reducing reagent into the diesel exhaust stream of a lean burn engine where little or no added weight or packaging length is required. Further, it would be advantageous to provide an exhaust gas treatment system which improves emission certification and facilitates the reduction of clogging.

The methods and apparatus of the present invention provide the foregoing and other advantages.

### SUMMARY OF THE INVENTION

There is disclosed herein an improved method for reducing NOₓ in an exhaust gas stream of a diesel-engine vehicle.

Generally speaking, the method comprises fluidly coupling components of an exhaust gas treatment system package to an engine exhaust gas system, then injecting gaseous ammonia into the exhaust gas treatment system package, beginning reaction of the gaseous ammonia with engine exhaust gas at a temperature of less than about 180° C., preferably about 150° C., and then continuing the reaction of the gaseous ammonia with the engine exhaust gas during operation of the vehicle.

In an embodiment of the present method, the reaction temperature is about 150° C. and the exhaust gas treatment system package includes a mixing chamber for reacting gaseous ammonia with vehicle exhaust gas to reduce NOₓ in the exhaust gas. The other standard components of the system include a diesel oxidation catalyst (DOC), a diesel particulate filter (DPF), a NOₓ slip catalyst (NSC) canister, wherein the DOC, DPF and NSC are all fluidly coupled together and to the mixing chamber, an injection port for adding gaseous ammonia to the mixing chamber, and a solid ammonia source for supplying gaseous ammonia to the injection port.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic illustrating a typical aqueous urea mixer/injector device for a diesel exhaust system;

FIG. 2 is a schematic illustrating an embodiment of a mixer/NH₃ injection device of the present invention for a diesel exhaust system; and

FIG. 3 is a schematic illustrating another embodiment of a mixer/NH₃ injection device of the present invention in a diesel exhaust system.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

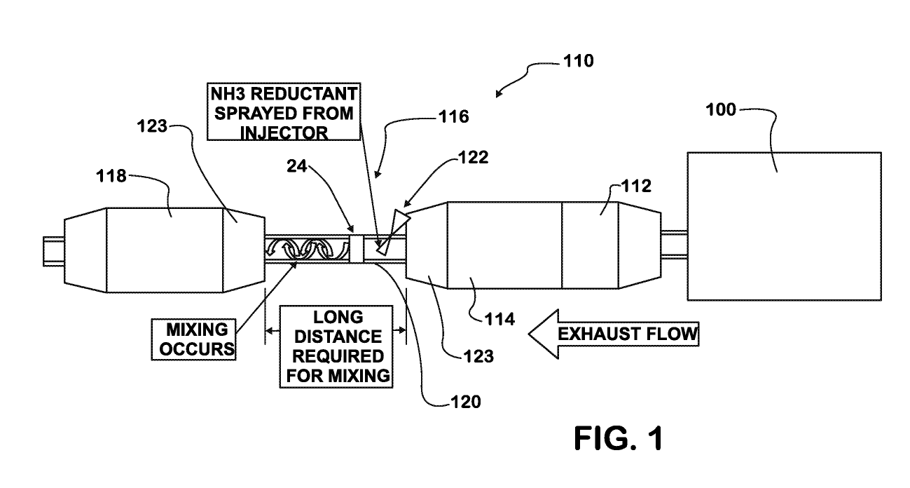

Referring to FIG. 1, there is illustrated a typical exhaust gas treatment system package 110. Exhaust gas is discharged from the diesel engine 100, through conduit such as exhaust piping to the exhaust gas treatment system 110. The exhaust gas treatment system 110 typically consists of, in order of exhaust gas flow, a diesel oxidation catalyst (DOC) 112, a diesel particulate filter (DPF) 114, a mixing chamber 116, and a NOₓ slip catalyst (NSC) 118. The DOC 112, DPF 114 and NSC 118 are additional exhaust gas treatment structures present in most diesel exhaust gas treatment systems and which form no part of the present system 10. Such structures will be generally referenced herein and identified in the drawing figures but, as each of these additional exhaust treatment structures is commonly understood by those skilled in the art, a detailed discussion of each is avoided for the purpose of focusing discussion on the system 10 as set forth in the appended claims.

The mixing chamber 116 is shown to include a connection pipe 120 with an injector 122 at the upstream end where aqueous urea is injected into a laminar diesel exhaust flow as it is discharged from the DOC 112 and DPF 114. The urea/exhaust stream proceeds through the mixing chamber 116 where the urea is converted to a gaseous ammonia which is capable of reacting with the NOₓ of the exhaust gas. A substantial length of pipe 120 is needed to allow for adequate mixing of the two components before the flow enters the NSC 118. As such, the mixing chamber 116 adds packaging length and weight to the diesel exhaust system 100 which might otherwise be used for other after-treatment substrates.

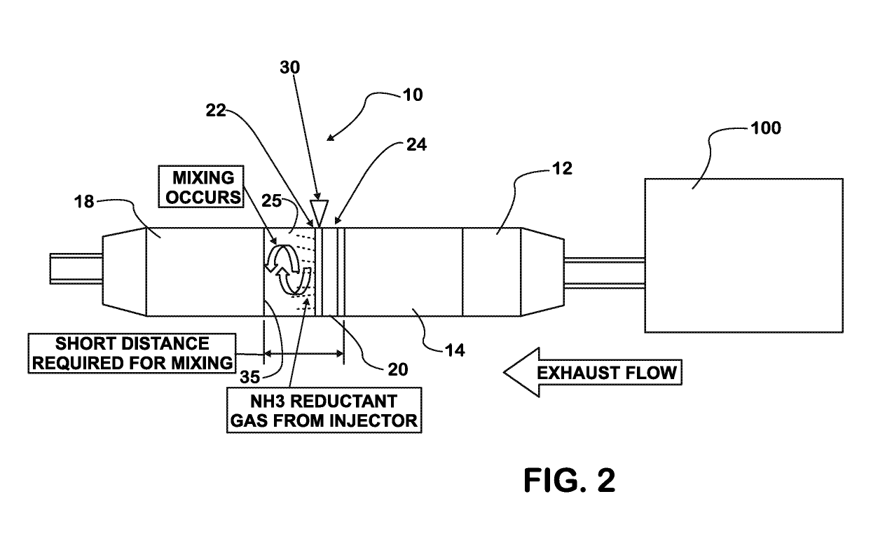

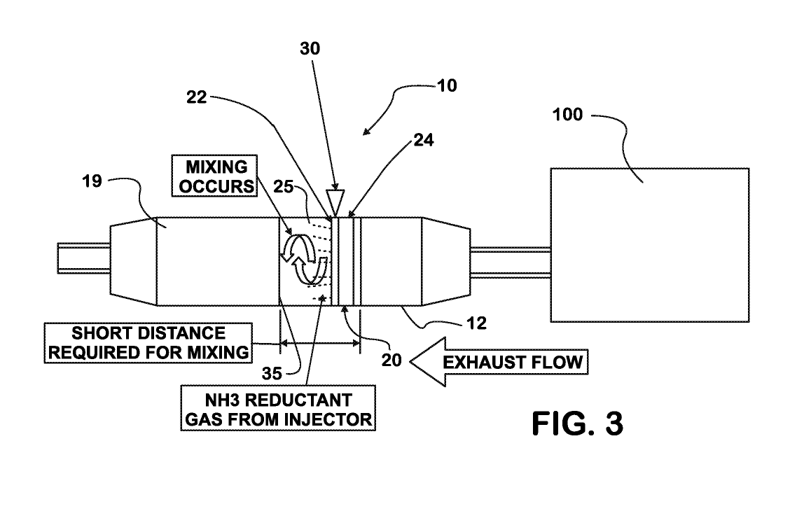

Referring to FIGS. 2-3, there is illustrated a diesel engine exhaust gas treatment system, generally designated by the numeral 10. The system 10 is shown in two distinct exhaust gas treatment configurations. FIG. 2 illustrates an exhaust gas configuration similar to that of FIG. 1 where the downstream order of components is DOC 12, then DPF 14 and NSC 18 sandwiched about a mixing chamber 216. Alternatively, FIG. 3 illustrates a configuration where the NSC 18 is on the DPF 14—i.e., NOₓ slip catalyst on diesel particulate filter (NPF) 19—sandwiching the mixing chamber 216 with the DOC 12. Other configurations may exist in which the mixing chamber 216 is moved up or downstream in the exhaust flow.

Regardless of the specific configuration, it is clear from examination of FIGS. 2 and 3 that the packaging space required for the mixing chamber 216 is substantially reduced from that required for a typical mixing chamber 116 illustrated in FIG. 1. The reduced packaging length is made possible by the injection of gaseous ammonia (NH₃) into the mixing chamber, as opposed to injecting aqueous urea which must then react for a length of the mixing chamber 216 to convert to NH₃. Further, the gaseous ammonia reacts with the exhaust gas to reduce NOₓ at a lower temperature than is required to convert the urea to gaseous ammonia. Accordingly, particularly after a cold start, the reduction of NOₓ in the exhaust stream begins much sooner with the present system.

Another benefit of the lower temperature NOₓ reduction relates to Federal Test Procedure (FTP) for emissions on diesel-engine vehicles. FTP certifications are typically cumulative and often have a “cold cycle” component as part of the test procedure. For example, in one such FTP engine emission certification process, the “cold cycle” component accounts for one-seventh of the overall test while the “hot cycle” component results make up the remaining six-sevenths. As noted above, the improved lower temperature reaction time in NOₓ emission control as a result of injecting gaseous ammonia into the exhaust stream, results in improved “cold cycle” test results over prior urea systems. As the test results are cumulative, the improvements in the “cold cycle” component provide greater flexibility in the more harsh “hot cycle” component of the test procedure. Successful certification of diesel engine vehicles using the present NOₓ emission control system 10 is increased as a result.

In fact, improved “cold cycle” testing results provide the ability to use less NOₓ washcoat in exhaust after-treatment canisters. The use of less washcoat is a cost savings over prior art systems.

Clogging/blockage and pressure drops in urea systems are also a problem overcome by the present exhaust treatment system 10. The very nature of an exhaust system results in a considerable amount of soot being deposited in various nooks, recesses, corners and other such areas of the system. The injection of liquid urea can mix with the accumulated soot and cake in passages to cause clogging/blockage and critical pressure drops which may result in backflow of exhaust. If not cleaned from the exhaust system, such accumulated caking can increase weight within the exhaust system.

However, with the injection of gaseous ammonia there is no increased risk of caking with the accumulated soot. Instead it is just the contrary, as the ammonia gas entrains the soot and carries it from the present exhaust system 10. Decreased pressure drops, decreased clogging, and decreased weight are the positive result of the ammonia gas injection.

Structurally speaking, the present mixing chamber 216 is comprised of a housing 20 defining a volume 25, an injection tube 22 fed by an exterior injector boss 30 coupled to a supply (not shown), and a mixer 24. FIGS. 2 and 3 illustrate the diameter of the housing 20 (approx. 12 inches (30.5 cm)) is substantially equal to that of the surrounding exhaust gas treatment structures—e.g., DPF 14 and NSC 18. By providing the larger diameter system housing 20 (vs. narrow connecting pipe 120), the need for reducers 123 (FIG. 1) is eliminated, further reducing the packaging size of the entire diesel exhaust treatment system.

Reagent (e.g., gaseous NH₃) discharged from injection points 23 immediately enters the turbulent diesel exhaust stream as it moves toward the chamber exit 35 (FIGS. 2 and 3). As stated above, a relatively short distance is needed to provide the necessary mixing time to create a homogonous reagent/diesel exhaust.

The homogenous mixture is then exited from the mixing chamber 25 into one of either the NSC 18 (FIG. 2) or the NPF 19 (FIG. 3) for further treatment.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for reducing NOₓ in an exhaust gas stream of a diesel-engine vehicle, the method comprising the steps of:
fluidly coupling components of an exhaust gas treatment system package to an engine exhaust gas system;
injecting gaseous ammonia into the exhaust gas treatment system package;
initiating reaction of the gaseous ammonia with engine exhaust gas at a temperature of less than about 180° C.; and
continuing reaction of the gaseous ammonia with the engine exhaust gas.

2. The method of claim 1, wherein the reaction temperature is about 150° C.

3. The method of claim 1, wherein the components of the exhaust gas treatment system package comprise a mixing chamber for reacting gaseous ammonia with vehicle exhaust gas to reduce NOₓ in the exhaust gas.

4. The method of claim 3, wherein the components of the exhaust gas treatment system package further comprises:
a diesel oxidation catalyst (DOC);
a diesel particulate filter (DPF);
a NOₓ slip catalyst (NSC) canister, wherein the DOC, DPF and NSC are all fluidly coupled together and to the mixing chamber;
an injection port for adding gaseous ammonia to the mixing chamber; and
a solid ammonia source for supplying gaseous ammonia to the injection port.

5. The method of claim 1, wherein the step of continuing reaction comprises the step of allowing the reaction temperature to exceed 180° C.

6. The method of claim 3, wherein the step of injecting gaseous ammonia occurs in the mixing chamber.

7. The method of claim 6, wherein the injection of gaseous ammonia begins before the mixing chamber achieves a temperature of 180° C.
